(19) United States
(12) Patent Application Publication
(10) Pub. No.: US 2010/0147232 A1
(43) Pub. Date: Jun. 17, 2010

(54) SYSTEM AND METHOD FOR IMPROVING FUEL ECONOMY IN COMBUSTION ENGINES

(75) Inventors: Kevin Heath, Interlachen, FL (US); Barry Gardner, Clearwater, FL (US); Bill Lang, Clearwater, FL (US); Tom Lang, Clearwater, FL (US)

Correspondence Address: LARSON AND LARSON, 11199 69TH STREET NORTH, LARGO, FL, 33773, US

(73) Assignee: SOLUTIONS WITH WATER, LLC, Largo, FL (US)

(21) Appl. No.: 12/333,387

(22) Filed: Dec. 12, 2008

(51) Int. Cl. F02B 43/10; F02B 47/00

(52) U.S. Cl. 123/3

(57) ABSTRACT

An application for a system and method for generating browns gas (mixture of oxygen and hydrogen) from a direct current power source is disclosed. The browns gas is mixed with fossil fuels such as gasoline, ethanol and diesel before combustion in a combustion engine. In such, the efficiency of the combustion engine is improved while reducing emissions of pollutants. A unique grid arrangement is immersed in an electrolyte for generating browns gas. The grid assembly includes conductive plates that are insulated and interspersed between positively biased plates and negatively biased plates, thereby improving the efficiency of the electrolysis.

### FIELD OF THE INVENTION

This invention relates to the field of combustion engines and more particularly to a system for safely generating browns gas for introduction into combustion engines.

### BACKGROUND

It is known that the introduction of hydrogen gas into a combustion engine along with air and fossil fuels will greatly increase fuel mileage and result in lower emissions and cooler operating temperatures. It is known to generate browns gas (hydrogen and oxygen mixture) through electrolysis that uses DC current to separate water molecules into a mixture of hydrogen and oxygen. Hydrogen is used as a primary fuel in several countries, for example taxis in Japan are fueled by hydrogen. To date, there has been little movement in providing hydrogen-refueling stations ubiquitously throughout any country. Furthermore, hydrogen fuel introduction is complicated due to heavy high-pressure fuel containers, and the lack of a practical and economical production of hydrogen fuel.

U.S. Pat. No. 7,261,062 to Holt, et al, describes a water to browns gas generator in which the browns gas is introduced into the combustion chamber. The browns gas generator in this patent requires a large amount of DC current and requires storage of the browns gas in a suitable container.

U.S. Pat. No. 5,513,600 to Teves describes a water to browns gas converter. This patent has a separate injector to inject the browns gas into the cylinder of the combustion engine. It is beneficial to utilize the existing carburetion or injection system of a combustion engine without requiring substantial modifications to existing engines.

Several needs exist in the industry to provide improved mileage to new and/or existing vehicles, especially when vehicles last from 10 to 30 years or more. It is desired to produce the required browns gas as needed, as efficiently as possible and as safely as possible.

What is needed is a system that will generate browns gas for introduction into the combustion chamber of combustion engines.

### SUMMARY OF THE INVENTION

The present invention provides for a system and method for generating browns gas (mixture of oxygen and hydrogen) from a direct current power source as a supplement to fossil fuels such as gasoline, ethanol and diesel. Efficiency is increased and pollutants are reduced by mixing the browns gas with the fossil fuel before combustion. The present invention provides for a unique grid arrangement for using electricity and water to generate browns gas and, in some embodiments, includes a controlled outside air inlet. In some embodiments, back flash is prevented by percolating the browns gas through a liquid.

In one embodiment, a system for improving an efficiency of a combustion engine is disclosed including a container for holding an electrolyte and holding an electrolyzer grid for generating browns gas. The electrolyzer grid comprising a first set of the plates electrically connected to a positive source of electricity, a second set of plates electrically connected to a negative source of electricity and a third set of plates insulated from the first set of plates and the second set of plates. At least one of the third set of plates is positioned in between a positive plate of the first set plates and a negative plate of the second set of plates. The electrolyzer grid is held within the container and submerged in the electrolyte. An outlet is located on the container above the electrolyte. Browns gas passes out of the outlet, to an air intake system of the combustion engine.

In another embodiment, a method of improving an efficiency of a combustion engine is disclosed including providing an electrolyzer for producing browns gas, the electrolyzer includes a container holding an electrolyte and an electrolyzer grid for generating browns gas. The electrolyzer grid includes a first set of the plates electrically connected to a positive terminal, a second set of plates electrically connected to a negative terminal and a third set of plates insulated from the first set of plates and the second set of plates. At least one of the third set of plates is positioned in between a positive plate of the first set plates and a negative plate of the second set of plates. The electrolyzer grid is held within the container and submerged in the electrolyte. The electrolyzer includes an outlet on the container located above the electrolyte. The outlet passes the browns gas out of the container. The method continues with connecting the outlet to an air intake of the combustion engine then connecting the positive terminal to a positive battery terminal and connecting the negative terminal to a negative battery terminal. Browns gas from the outlet is drawn into the air intake during operation of the combustion engine, thereby improving the efficiency of the combustion engine.

In another embodiment, an electrolyzer for improving an efficiency of a combustion engine is disclosed including a container holding an electrolyte and a lid for covering the container. The lid removably affixed to the container. An electrolyzer grid for generating browns gas is positioned within the container. The electrolyzer grid includes a first set of the plates electrically connected to and supported by an anode, a second set of plates electrically connected to and supported by a cathode, a third set of plates supported by and insulated from the anode and a fourth set of plates supported by and insulated from the cathode. At least one of the third set of plates and the fourth set of plates is positioned in between a positive plate of the first set plates and a negative plate of the second set of plates. The electrolyzer grid is held within the container and submerged in the electrolyte. A first end of the anode passes through the lid for connection to a positive voltage and a first end of the cathode passes through the lid for connection to a negative voltage. The lid has an outlet, the outlet passing the browns gas out of the container. The lid also has an outside air inlet having a valve that controls a rate of flow of outside air into the electrolyzer. The outside air inlet is fluidly coupled to a first end of an outside air riser and a second end of the outside air riser is immersed in the electrolyte.

In another embodiment, an apparatus for improving an efficiency of a combustion engine is disclosed including an electrolyzer and a back flash arrestor. The electrolyzer has a container holding an electrolyte and a lid for covering the container. The lid is removably affixed to the container. An electrolyzer grid for generating browns gas is positioned within the container. The electrolyzer grid includes a first set of the plates electrically connected to and supported by an anode, a second set of plates electrically connected to and supported by a cathode, a third set of plates supported by and insulated from the anode and a fourth set of plates supported by and insulated from the cathode. At least one of the third set of plates and the fourth set of plates is positioned in between a positive plate of the first set plates and a negative plate of the second set of plates. The electrolyzer grid is held within the container and submerged in the electrolyte. A first end of the anode passes through the lid for connection to a positive voltage and a first end of the cathode passes through the lid for connection to a negative voltage. The lid has an outlet, the outlet passing the browns gas out of the container. The lid also has an outside air inlet having a valve that controls a rate of flow of outside air into the electrolyzer. The outside air inlet is fluidly coupled to a first end of an outside air riser and a second end of the outside air riser is immersed in the electrolyte.

The back flash arrestor has a back flash arrestor lid. A back flash inlet and a back flash outlet are on the lid. The outlet of the electrolyzer is fluidly coupled to the back flash inlet. A back flash container holding a liquid is removably affixed to the lid. The back flash arrestor includes a browns gas riser tube. A first end of the browns gas riser tube is fluidly connected to the back flash inlet and a second end of the browns gas riser tube is immersed in the liquid. The back flash outlet is fluidly coupled to an air intake of the combustion engine.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a browns gas generating system of the present invention.

FIG. 2 illustrates a second perspective view of the browns gas generating system of the present invention.

FIG. 3 illustrates a schematic view of the browns gas generating system of the present invention.

FIG. 4 illustrates a perspective view of a grid system of the browns gas generating system of the present invention.

FIG. 5 illustrates a perspective view of a browns gas generating system of the present invention connected to the vacuum line of a carburetor of a combustion engine.

FIG. 6 illustrates a perspective view of a browns gas generating system of the present invention connected to the air intake of a carburetor of a combustion engine.

FIG. 7 illustrates a schematic view of the flow of gases through a browns gas generating system of the present invention.

FIG. 8 illustrates a schematic view of an exemplary electrical connection for a browns gas generating system of the present invention.

FIG. 9 illustrates a schematic view of another exemplary electrical connection for a browns gas generating system of the present invention.

### DETAILED DESCRIPTION OF THE PREFERRED EMBODIMENT

Reference will now be made in detail to the presently preferred embodiments of the invention, examples of which are illustrated in the accompanying drawings. Throughout the following detailed description, the same reference numerals refer to the same elements in all figures.

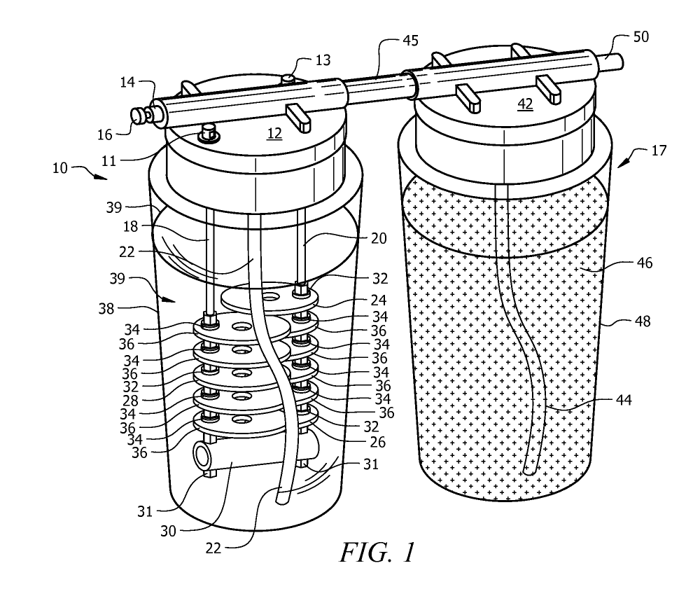

Referring to FIG. 1, a perspective view of a browns gas generating system of the present invention is shown. The browns gas is produced by electrolysis in the gas production plant 10. To prevent a backfire or other spark from causing combustion of any browns gas present in the gas production plant 10, a back flash arrestor 17 is provided in the preferred embodiment.

The browns gas production plant 10 includes a container 38 for containing an electrolyte 39 and having a lid 12 that attaches to the container 38 in ways known in the industry, preferably by threads in the lid 12 and on the lip of the container 38. Within the container 38 is a grid arrangement having alternating plates 24/26/28/36. Some of the plates 28 are connected to a negative direct current power source through an anode 18 and a negative connection terminal 11. Some of the plates 24/26 are connected to the positive direct current power source through a cathode 20 and a positive connection terminal 13. One or more plates 36 are insulated from the anode 18 and the cathode 20. Such a plate arrangement provides a more uniform current flow through the electrolyte 39, thereby improving the efficiency of the gas generation. As shown, the top plate 24 and the bottom plate 26 are connected to the cathode 20 and the middle plate 28 is connected to the anode 18 through, as an example, conductive washers 32 although there is no requirement to use any particular conductive washer 32. Other ways to connect the active plates 24/26/28 to the anode 18 or cathode 20 are anticipated and included here within. The remaining plates 36 are preferably, though not required, supported by the anode 18 or the cathode 20 and insulated from the anode 18 or and/or the cathode 20. The example shown in FIG. 1 uses insulating washers 34 to insulate the non-connected plates 36 from the anode 18 and/or cathode 20. The plates are made form any suitable conductive material including, but not limited to, stainless steel, copper, platinum and titanium. In some embodiments, the plates are any suitable material coated or electroplated with a suitable conductive material such as platinum and titanium.

It is anticipated that in some embodiments, the anode 18 and the cathode 20 are covered with an insulator (not visible in FIG. 1) to prevent flow of current directly between them.

In some embodiments, the container 38 is made from a durable plastic material and is preferably clear, providing a visual indication of the level of the electrolyte 39. Alternately, any suitable material is envisioned for the container 38. Likewise, the lid 12 is also made, for example, of a durable plastic of any color or clarity and, preferably, having insulating qualities to insulate the negative connection terminal 11 from the positive connection terminal 13.

In the preferred embodiment, situated on the lid 12 is an outside air inlet 14 with an air volume adjustment valve 16. The air inlet 14 and air volume adjustment valve 16 are anticipated to be any type as known in the industry and are provided to adjustably introduce a limited volume of outside air into the container 38. To prevent browns gas from exiting through the outside air inlet 14, the outside air inlet 14 is in fluid communication with an air inlet riser tube 22 that terminates within the electrolyte 39 such that as air is drawn into the container 38, the air passes through the air inlet riser tube 22 and percolates up through the electrolyte 39 where it is mixed with the browns gas in an area of the container above the electrolyte.

The electrolyte 39 fills up the container 30 at least high enough as to immerse the plates 24/26/28/36. Any electrolyte known is anticipated including water mixed with an agent to enhance conduction such as sodium chloride (salt).

The plates 24/26/28/36 include active plates 24/26/28 and insulated plates 36. Some plates 28 are connected to a negative voltage potential by way of the anode 18. Some of the plates 24/26 are connected to a positive voltage potential by way of the cathode 20. Some of the plates 36 are insulated from either the anode 18 or the cathode 20. Although not required, it is preferred to have at least one insulated plate 36 between the negatively biased plate(s) 28 and the positively biased plate(s) 24/26. Having such insulated plates 36 improve the efficiency of the electrolysis by improving the distribution of current flow through the electrolyte 39. As shown, there are three insulated plates 36 between the upper positively biased plate 24 and the negatively biased plate 28 and three insulated plates 36 between the lower positively biased plate 26 and the negatively biased plate 28. In alternate embodiments, any other number of insulated plates 36, negatively biased plates 28 and positively biased plates 24/26 are anticipated. Although, in this example, plates 24/26/28/36 are alternatively physically supported by the cathode 20 and the anode 18, any other configuration of support is anticipated. For example, in one embodiment, all of the insulated plates 36 and the positively biased plates 24/26 are supported by the cathode 20 and only the negatively biased plate 28 is supported by the anode 18. Alternately, a separate, insulated support rod (not shown) supports the insulated plates 36. In some embodiments, the insulated plates 36 are insulated from each other while in other embodiments; one or more insulated plates are electrically coupled to each other.

Although not required, in some embodiments a stiffening member 30 is present between the lower ends of the anode 18 and cathode 20 to maintain alignment of the anode 18 and cathode 20. As shown, the stiffening member 30 is a tube and is affixed to the anode 18 and cathode 20 by nuts 31, although any known fastener is anticipated. When present, the stiffening member 30 is made of a resilient, insulating material or is insulated from the anode 18 and cathode 20.

To prevent a backfire or other spark from causing combustion of any browns gas present in the gas production plant 10, a back flash arrestor 17 is provided in the preferred embodiment. In this exemplary system, the back flash arrestor 17 includes a back flash container 48 having a liquid 46 such as water, salt water or antifreeze; and a lid 42. Browns gas from the browns gas production plant 10 flows through an interface tube or pipe 45 that is in fluid communication with a browns gas riser tube 44. A distal end of the browns gas riser tube 44 is immersed in the liquid 46 and the browns gas percolates out of the distal end of the browns gas riser tube 44 to an area above the liquid 46 where it passes out of the system through an outlet 50. Should a spark occur downstream from the back flash arrestor 17, only a small amount of browns gas present in the back flash container 48 would ignite and the flame would not pass down through the liquid 46 and back into the browns gas production plant 10.

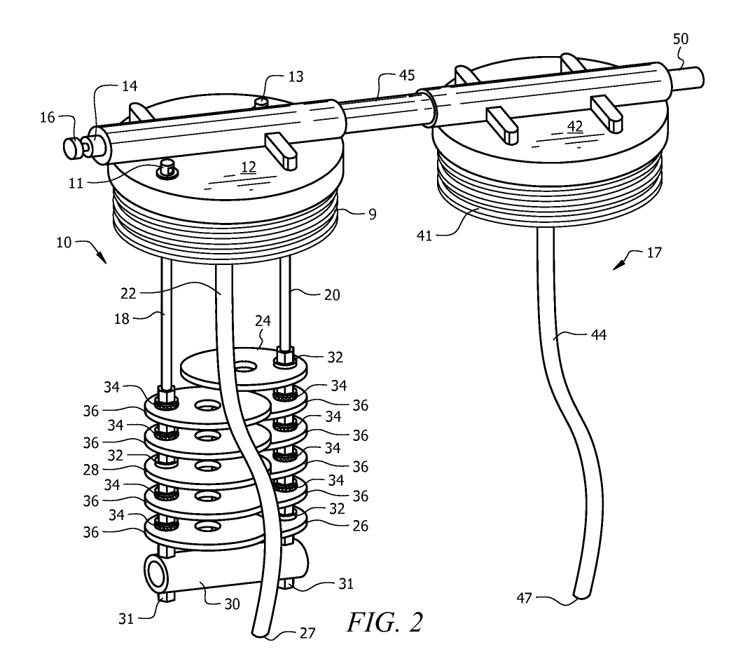

Referring to FIG. 2, a second perspective view of the browns gas generating system of the present invention is shown. The browns gas is produced by electrolysis in the gas production plant 10 shown without the container 38 and without the electrolyte 39 (see FIG. 1). To prevent a backfire or other spark from causing combustion of any browns gas present in the gas production plant 10, a back flash arrestor 17 is provided in the preferred embodiment, shown without the cover 48 and liquid 46 (see FIG. 1).

The browns gas production plant 10 has a lid 12 that attaches to the container 38 in ways known in the industry (See FIG. 1); preferably by threads 9 in the lid 12 and on the lip of the container 38 (not shown). Some of the plates 28 are connected to the negative direct current power source through the anode 18 and the negative connection terminal 11. Some of the plates 24/26 are connected to the positive direct current power source through the cathode 20 and the positive connection terminal 13. One or more plates 36 are insulated from the anode 18 and the cathode 20. Such a plate arrangement provides a more uniform current flow through the electrolyte 39 (see FIG. 1), thereby improving the efficiency of the gas generation. As shown, the top plate 24 and the bottom plate 26 are connected to the cathode 20 and the middle plate 28 is connected to the anode 18 through, as an example, conductive washers 32 although there is no requirement to use any particular conductive washer 32. Other ways to connect the active plates 24/26/28 to the anode 18 or cathode 20 are anticipated and included here within. The remaining plates 36 are preferably, though not required, supported by the anode 18 or the cathode 20 and insulated from the anode 18 or and/or the cathode 20. The example shown in FIG. 2 uses insulating washers 34 to insulate the non-connected plates 36 from the anode 18 and/or cathode 20.

It is anticipated that in some embodiments, the anode 18 and the cathode 20 are covered with an insulator (not visible in FIG. 2) to prevent flow of current directly between them.

In the preferred embodiment, situated on the lid 12 is an outside air inlet 14 with an air volume adjustment valve 16. The air inlet 14 and air volume adjustment valve 16 are anticipated to be any type as known in the industry and are provided to adjustably introduce a limited volume of outside air into the container 38 (see FIG. 1). To prevent browns gas from exiting through the outside air inlet 14, the outside air inlet 14 is in fluid communication with an air inlet riser tube 22. A distal end 27 of the air inlet riser tube 22 terminates within the electrolyte 39 (see FIG. 1) such that as air is drawn into the container 38 (see FIG. 1), the air passes through the air inlet riser tube 22 and percolates up through the electrolyte 39 (see FIG. 1) where it is mixed with the browns gas in an area of the container above the electrolyte.

The plates 24/26/28/36 include active plates 24/26/28 and insulated plates 36. Some plates 28 are connected to a negative voltage potential by way of the anode 18. Some of the plates 24/26 are connected to a positive voltage potential by way of the cathode 20. Some of the plates 36 are insulated from either the anode 18 or the cathode 20. Although not required, it is preferred to have at least one insulated plate 36 between the negatively biased plate(s) 28 and the positively biased plate(s) 24/26. Having such insulated plates 36 improve the efficiency of the electrolysis by improving the distribution of current flow through the electrolyte 39. As shown, there are three insulated plates 36 between the upper positively biased plate 24 and the negatively biased plate 28 and three insulated plates 36 between the lower positively biased plate 26 and the negatively biased plate 28. In alternate embodiments, any other number of insulated plates 36, negatively biased plates 28 and positively biased plates 24/26 are anticipated. Although, in this example, plates 24/26/28/36 are alternatively physically supported by the cathode 20 and the anode 18, any other configuration of support is anticipated. For example, in one embodiment, all of the insulated plates 36 and the positively biased plates 24/26 are supported by the cathode 20 and only the negatively biased plate 28 is supported by the anode 18. Alternately, a separate, insulated support rod (not shown) supports the insulated plates 36. In some embodiments, the insulated plates 36 are insulated from each other while in other embodiments; one or more insulated plates are electrically coupled to each other.

Although not required, in some embodiments a stiffening member 30 is present between the lower ends of the anode 18 and cathode 20 to maintain alignment of the anode 18 and cathode 20. As shown, the stiffening member 30 is a tube and is affixed to the anode 18 and cathode 20 by nuts 31, although any known fastener is anticipated. When present, the stiffening member 30 is made of a resilient, insulating material or is insulated from the anode 18 and cathode 20.

To prevent a backfire or other spark from causing combustion of any browns gas present in the gas production plant 10, a back flash arrestor 17 is provided in the preferred embodiment. In this exemplary system, the back flash arrestor 17 includes a back flash container 48 (see FIG. 1) having a liquid 46 (see FIG. 1) such as water and a lid 42. The lid 42 attaches to the container 48 in ways known in the industry (see FIG. 1); preferably by threads 41 in the lid 42 and on the lip of the container 48 (not shown).

Browns gas from the browns gas production plant 10 flows through an interface tube or pipe 45 that is in fluid communication with a browns gas riser tube 44. A distal end 47 of the browns gas riser tube 44 is immersed in the liquid 46 (see FIG. 1) and the browns gas percolates out of the distal end 47 of the browns gas riser tube 44 to an area above the liquid 46 where it passes out of the system through an outlet 50. Should a spark occur downstream from the back flash arrestor 17, only a small amount of browns gas present in the back flash container 48 would ignite and the flame would not pass down through the liquid 46 and back into the browns gas production plant 10.

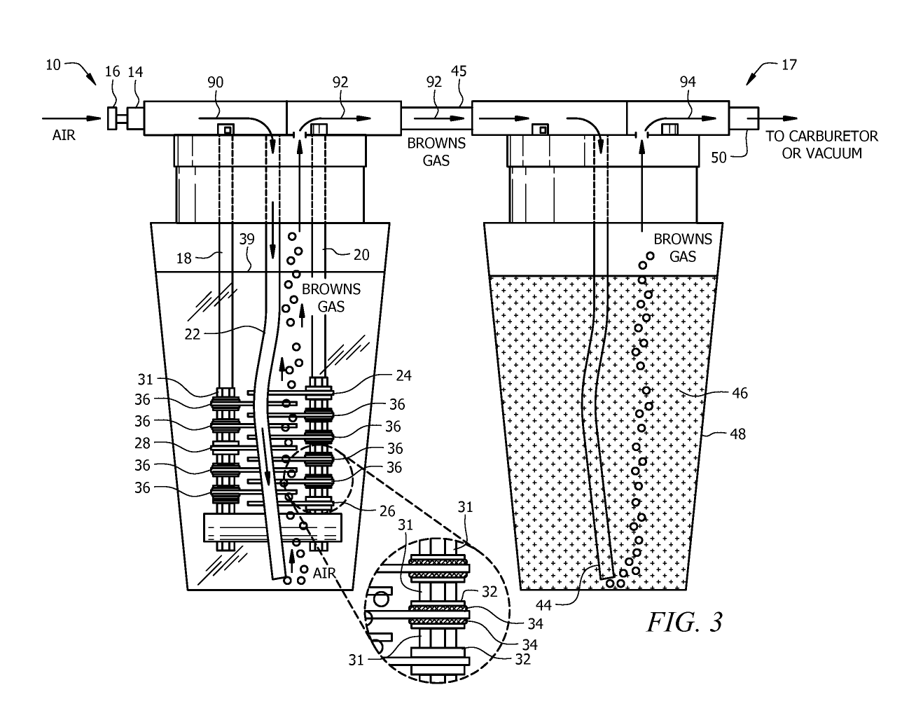

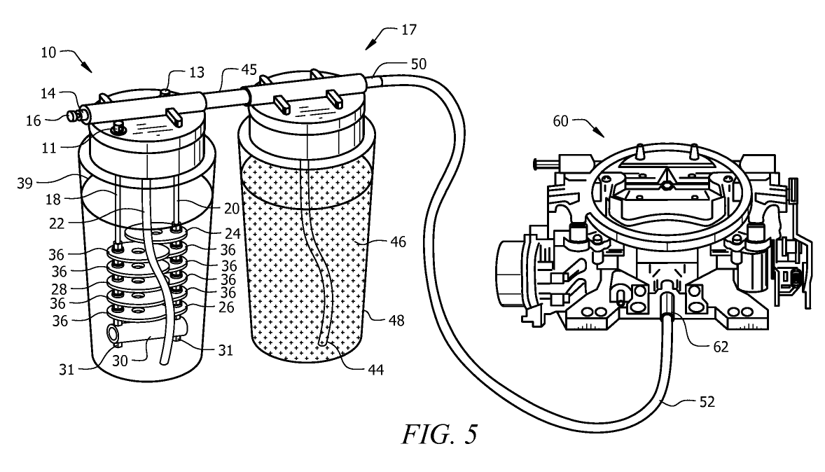

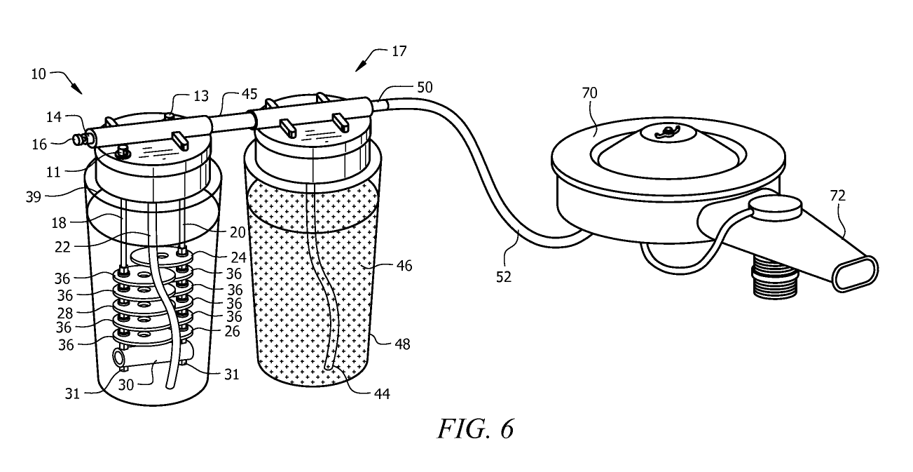

Referring to FIG. 3, a schematic view of the browns gas generating system of the present invention is shown. The present invention injects browns gas (hydrogen and oxygen) into the carburetor or vacuum system of a combustion engine. It is anticipated that the carburetor or vacuum system of the combustion engine will generate a negative pressure (e.g., vacuum) during operation, especially during higher revolutions per minute of the combustion engine. It is anticipated that this negative pressure is greater than the amount of browns gas that is generated by the browns gas production plant 10. Therefore, when the outside air inlet valve 14 is open as controlled by the air volume adjustment valve 16, outside air 92 enters the browns gas production plant 10 and passes through the air inlet riser tube 22 then percolates to the top of the electrolyte 39 along with any browns gas that is produced between the charged grid plates 24/26/28. The mixture 90 of browns gas and outside air exits the browns gas production plant 10 through the connector 45 and into the optional back flash arrestor 17. Within the optional back flash arrestor 17, the mixture 92 passes through the browns gas riser tube 44 then percolates through the liquid 46 and is collected above the liquid 46, the mixture 94 passing out of the optional back flash arrestor 17 to a connector 50 for eventual deliver to a carburetor air intake (see FIG. 6) or vacuum system (see FIG. 5).

In FIG. 3, details are shown of one possible configuration of plates 24/26/28/36. In this example, negative plates 28 are connected to the negative voltage potential by way of the anode 18. The negative plates 28 are electrically connected to the anode 18 through nuts 31 and metal washers 32. The positive plates 24/26 are connected to the positive voltage potential by way of the cathode 20. Likewise, the positive plates 24/26 are electrically connected to the cathode 20 through nuts 31 and metal washers 32. The insulated plates 36 are insulated from either the anode 18 or the cathode 20 by insulating washers 34 as known in the industry. In some embodiments, metal washers 32 are situated between the nuts 31 and the insulating washers 34 to improve structural integrity. Many other ways are known to mount, support and connect a grid of plates 24/26/28/36, all of which are included here within.

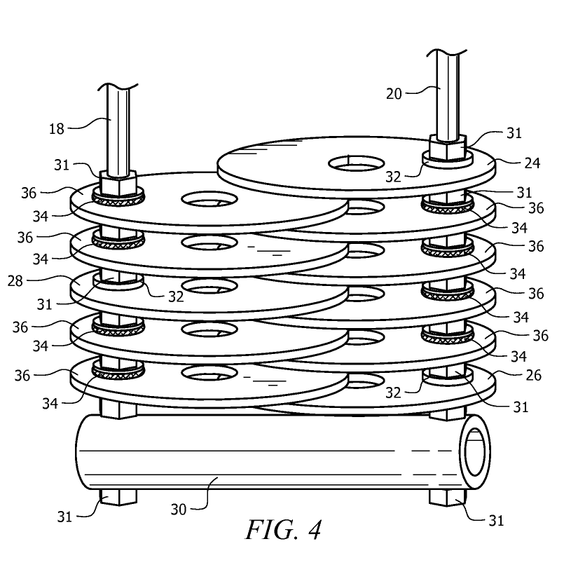

Referring to FIG. 4, a perspective view of a grid system of the browns gas generating system of the present invention is shown. Details are shown of one possible configuration of plates 24/26/28/36 having one negative plate 28, two positive plates 24/26 and eight insulating plates 36. In this example, the negative plate 28 is connected to the negative voltage potential by way of the anode 18. The negative plate 28 is electrically connected to the anode 18 through nuts 31 and metal washers 32. The positive plates 24/26 are connected to the positive voltage potential by way of the cathode 20. Likewise, the positive plates 24/26 are electrically connected to the cathode 20 through nuts 31 and metal washers 32. The insulated plates 36 are insulated from either the anode 18 or the cathode 20 by insulating washers 34 as known in the industry. In this embodiment, there are no metal washers 32 (see FIG. 3) situated between the nuts 31 and the insulating washers 34 and the insulating washers 34 provide structural integrity. Many other ways are known to mount, support and connect a grid of plates 24/26/28/36, all of which are included here within.

Although not required, in some embodiments a stiffening member 30 is present between the lower ends of the anode 18 and cathode 20 to maintain alignment of the anode 18 and cathode 20. As shown, the stiffening member 30 is a tube and is affixed to the anode 18 and cathode 20 by nuts 31, although any known fastener is anticipated. When present, the stiffening member 30 is made of a resilient, insulating material or is insulated from the anode 18 and cathode 20.

Referring to FIG. 5, a perspective view of a browns gas generating system of the present invention connected to the vacuum line of a carburetor of a combustion engine is shown. Browns gas is produced in the browns gas production plant 10 and mixed with outside air from the air inlet 14. The mixture of browns gas and outside air 92 is transferred to the back flash arrestor 17 through a connecting tube 45 where it percolates through a liquid 46 to reduce combustion caused by backfire or other ignition source. The mixture of browns gas and outside air 94 leaves the back flash arrestor 17 through a hose adapter 50 and passes through a tube or hose 52 to a vacuum inlet port 62 of a carburetor 60. The carburetor 60 is attached to a combustion engine (not shown) and, as the combustion engine operates, the browns gas and outside air mixture 94 is drawn in through the vacuum inlet port 62 and into the combustion cylinder(s) of the combustion engine (not shown), thereby improving efficiency and reducing pollution.

Referring to FIG. 6, a perspective view of a browns gas generating system of the present invention connected to the air intake of a carburetor of a combustion engine is shown. Browns gas is produced in the browns gas production plant 10 and mixed with outside air from the air inlet 14. The mixture of browns gas and outside air 92 is transferred to the back flash arrestor 17 through a connecting tube 45 where it percolates through a liquid 46 to reduce combustion caused by backfire or other ignition source. The mixture of browns gas and outside air 94 leaves the back flash arrestor 17 through a hose adapter 50 and passes through a tube or hose 52 to a port on the air filter 70 of a combustion engine (not shown). The air filter 70 is attached to a combustion engine (not shown) and, as the combustion engine operates, the browns gas and outside air mixture 94 is drawn into the air filter 70 along with outside air from the air filter inlet 72 and into the combustion cylinder(s) of the combustion engine (not shown), thereby improving efficiency and reducing pollution.

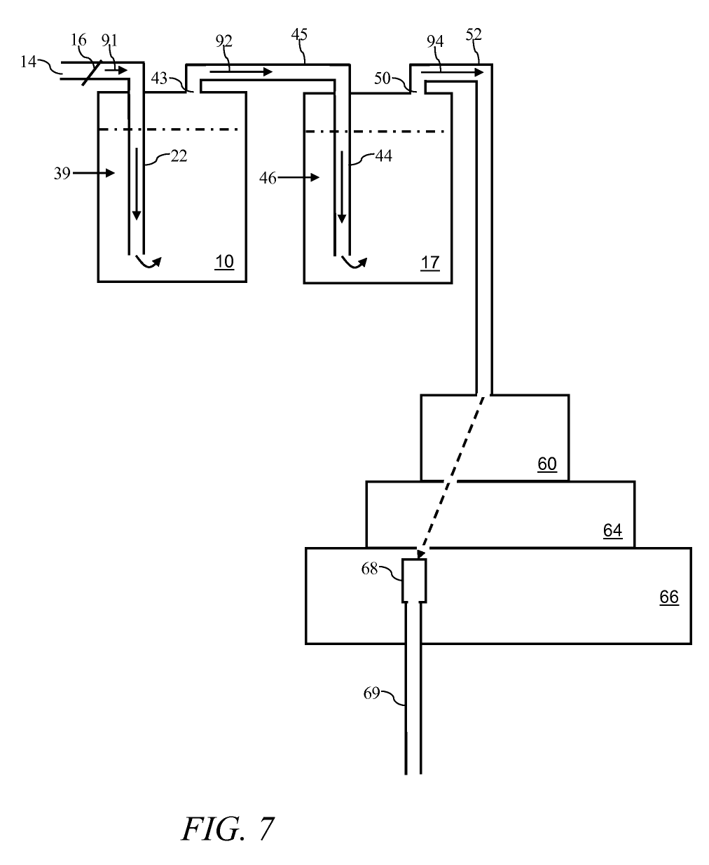

Referring to FIG. 7, a schematic view of the flow of gases through a browns gas generating system of the present invention is shown. Outside air 91 enters from the air inlet 14 under control of the air volume adjustment valve 16. The air 91 is delivered into the electrolyte 39 through the air inlet riser tube 22 and percolates up through the electrolyte mixing with the browns gas that is produced by electrolysis. The mixture of browns gas and outside air 92 exit through an outlet 43 on the electrolyzer (browns gas generating system) 10 and is transferred to the back flash arrestor 17 through a connecting tube 45 and the goes through the browns gas riser tube 44. The mixture percolates through a liquid 46 to reduce the danger of combustion caused by backfire or other ignition source. The mixture of browns gas and outside air 94 leaves the back flash arrestor 17 through a tube 52 to the vacuum input or air intake of the carburetor 60 of a combustion engine 66. As the combustion engine operates, the browns gas and outside air mixture 92 is drawn into the carburetor 60 along with outside air an fossil fuel (e.g., gasoline, diesel, etc), through the manifold 64 (or injection system) and into the combustion cylinder(s) 68 of the combustion engine, thereby improving efficiency and reducing pollutants exiting through the exhaust system 69.

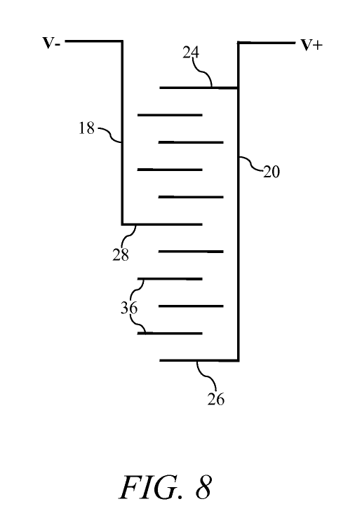

Referring to FIG. 8, a schematic view of an exemplary electrical connection for a browns gas generating system of the present invention is shown. A negative voltage potential, preferably from the battery system of a vehicle, is connected to the anode 18 and a positive voltage potential is connected to the cathode 20. In this example, the anode 18 is connected to one negatively biased plate 28 and the cathode 20 is connected to two positively biased plates 24/26 and there are several insulated plates 36 disposed between the negatively biased plate 28 and the positively biased plates 24/26. Any number of negatively biased plates 28, positively biased plate 24/26 and insulated plates 36 are anticipated. Although the plates 24/26/28/36 are shown equidistant, any equal or unequal spacing between the plates 24/26/28/36 is anticipated.

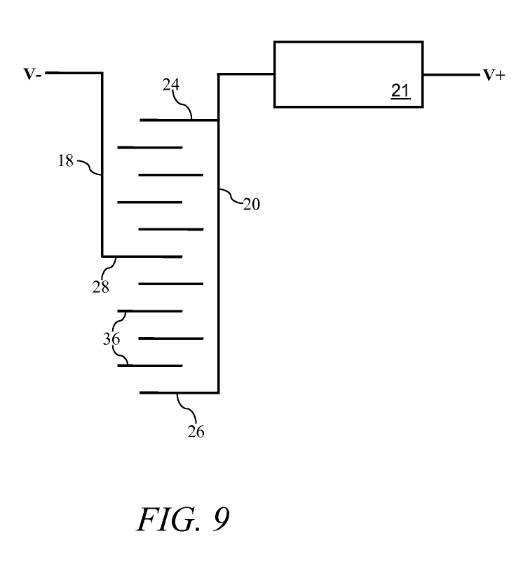

Referring to FIG. 9, a schematic view of another exemplary electrical connection for a browns gas generating system of the present invention is shown. A negative voltage potential, preferably from the battery system of a vehicle, is connected to the anode 18 and a positive voltage potential is connected to the cathode 20 through a current limiting resistor 21. In this example, the anode 18 is connected to one negatively biased plate 28 and the cathode 20 is connected to two positively biased plates 24/26 and there are several insulated plates 36 disposed between the negatively biased plate 28 and the positively biased plates 24/26. Any number of negatively biased plates 28, positively biased plate 24/26 and insulated plates 36 are anticipated. Although the plates 24/26/28/36 are shown equidistant, any equal or unequal spacing between the plates 24/26/28/36 is anticipated.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for improving an efficiency of a combustion engine, the system comprising:
a container holding an electrolyte;
an electrolyzer grid for generating browns gas, the electrolyzer grid comprising a first set of plates electrically connected to a positive source of electricity, a second set of plates electrically connected to a negative source of electricity and a third set of plates insulated from the first set of plates and the second set of plates; whereas at least one of the third set of plates is positioned in between a positive plate of the first set plates and a negative plate of the second set of plates; whereas the electrolyzer grid is held within the container and submerged in the electrolyte; and
an outlet on the container located above the electrolyte, the outlet passing the browns gas out of the container, the outlet coupled to an air intake system of the combustion engine.

2. The system of claim 1, wherein the container further comprises an outside air inlet port for introducing air into the container.

3. The system of claim 2, wherein the outside air inlet port includes a valve to control a rate of flow of the air into the container.

4. The system of claim 3, wherein the outside air inlet port is fluidly connected to a first end of an outside air riser tube, a distal end of the outside air riser tube is submerged in the electrolyte.

5. The system of claim 1, further comprising a back flash arrestor connected to the outlet, the back flash arrestor comprising a second container holding a liquid, a browns gas riser tube, a back flash inlet and a back flash outlet; the back flash inlet connected to the outlet and connected to a first end of the browns gas riser tube; a second end of the browns gas riser tube immersed in the liquid and the back flash outlet is situated on the second container above the liquid.

6. The system of claim 1, wherein the first set of the plates are electrically connected to the positive source of electricity and supported by an anode, one end of the anode extending outside of the container.

7. The system of claim 1, wherein the a second set of plates are electrically connected to the negative source of electricity and supported by a cathode, one end of the cathode extending outside of the container.

8. The system of claim 1, wherein the container includes a container portion and a lid and whereas the lid is removably affixed to the container portion and the outlet is situated on the lid.

9. The system of claim 8, wherein the container further comprises an outside air inlet port situated on the lid for introducing air into the container.

10. The system of claim 1, wherein the air intake system of the combustion engine is a vacuum port of a carburetor of the combustion engine.

11. The system of claim 1, wherein the air intake system of the combustion engine is an air filter housing interfaced to a carburetor of the combustion engine.

12. A method of improving an efficiency of a combustion engine, the method comprising:
providing an electrolyzer, the electrolyzer producing browns gas, the electrolyzer comprising:
a container holding an electrolyte;
an electrolyzer grid for generating browns gas, the electrolyzer grid comprising a first set of plates electrically connected to a positive terminal, a second set of plates electrically connected to a negative terminal and a third set of plates insulated from the first set of plates and the second set of plates; whereas at least one of the third set of plates is positioned in between a positive plate of the first set plates and a negative plate of the second set of plates; whereas the electrolyzer grid is held within the container and submerged in the electrolyte;
an outlet on the container located above the electrolyte, the outlet passes the browns gas out of the container;
connecting the outlet to an air intake of the combustion engine;
connecting the positive terminal to a positive battery terminal; and
connecting the negative terminal to a negative battery terminal; whereas the browns gas from the outlet is drawn into the air intake during operation of the combustion engine, thereby improving the efficiency of the combustion engine.

13. The method of claim 12, wherein the container further comprises an outside air inlet port for introducing air into the container and the outside air inlet port includes a valve to control a rate of flow of the air into the container and the method includes the step of adjusting the valve, thereby controlling the mixture of outside air and browns gas delivered to the air intake of the combustion engine.

14. The method of claim 13, wherein the outside air inlet port is fluidly connected to a first end of an outside air riser tube, a distal end of the outside air riser tube submerged in the electrolyte.

15. The system of claim 12, wherein the container includes a container portion and a lid and whereas the lid is removably affixed to the container portion and the outlet is situated on the lid.

16. An electrolyzer for improving an efficiency of a combustion engine, the electrolyzer comprising:
a container holding an electrolyte;
a lid for covering the container, the lid removably affixed to the container;
an electrolyzer grid for generating browns gas, the electrolyzer grid comprising a first set of plates electrically connected to and supported by an anode, a second set of plates electrically connected to and supported by a cathode, a third set of plates supported by and insulated from the anode and a fourth set of plates supported by and insulated from the cathode; whereas at least one of the third set of plates and the fourth set of plates is positioned in between a positive plate of the first set plates and a negative plate of the second set of plates; whereas the electrolyzer grid is held within the container and submerged in the electrolyte, and a first end of the anode passes through the lid for connection to a positive voltage and a first end of the cathode passes through the lid for connection to a negative voltage;
an outlet on the lid, the outlet passing the browns gas out of the container, the outlet coupled to an air intake system of the combustion engine; and
an outside air inlet on the lid having a valve that controls a rate of flow of outside air into the electrolyzer, the outside air inlet fluidly coupled to a first end of an outside air riser and a distal end of the outside air riser immersed in the electrolyte.

17. The electrolyzer of claim 16, wherein the electrolyte is water mixed with sodium chloride.

18. The electrolyzer of claim 16, further comprising an insulated stiffening member coupling a distal end of the anode to a distal end of the cathode.

19. An apparatus for improving an efficiency of a combustion engine, the apparatus comprising:
an electrolyzer, the electrolyzer comprising:
a container holding an electrolyte;
a lid for covering the container, the lid removably affixed to the container;
an electrolyzer grid for generating browns gas, the electrolyzer grid comprising a first set of plates electrically connected to and supported by an anode, a second set of plates electrically connected to and supported by a cathode, a third set of plates supported by and insulated from the anode and a fourth set of plates supported by and insulated from the cathode; whereas at least one of the third set of plates and the fourth set of plates is positioned in between a positive plate of the first set plates and a negative plate of the second set of plates; whereas the electrolyzer grid is held within the container and submerged in the electrolyte, and a first end of the anode passes through the lid for connection to a positive voltage and a first end of the cathode passes through the lid for connection to a negative voltage;
an outlet on the lid, the outlet passing the browns gas out of the container; and
an outside air inlet on the lid having a valve that controls a rate of flow of outside air into the electrolyzer, the outside air inlet fluidly coupled to a first end of an outside air riser and a distal end of the outside air riser immersed in the electrolyte;
a back flash arrestor, the back flash arrestor comprising:
a back flash arrestor lid having a back flash inlet and a back flash outlet, the outlet of the electrolyzer fluidly coupled to the back flash inlet;
a back flash container, the back flash container holding a liquid and the back flash container removably affixed to the lid; and
a browns gas riser tube, a first end of the browns gas riser tube fluidly connected to the back flash inlet and a distal end of the browns gas riser tube immersed in the liquid; whereas the back flash outlet is fluidly coupled to an air intake of the combustion engine.

20. The apparatus of claim 19, wherein the electrolyte is water mixed with sodium chloride.

21. The apparatus of claim 19, wherein the liquid is selected from the group consisting of water mixed with sodium chloride and antifreeze.

22. The apparatus of claim 19, wherein the air intake system of the combustion engine is a vacuum port of a carburetor of the combustion engine.

23. The apparatus of claim 19, wherein the air intake system of the combustion engine is an air filter housing interfaced to a carburetor of the combustion engine.

24. The apparatus of claim 19, further comprising an insulated stiffening member coupling a distal end of the anode to a distal end of the cathode.
